(19) United States
(12) Patent Application Publication
(10) Pub. No.: US 2011/0246075 A1
(43) Pub. Date: Oct. 6, 2011

(54) Providing a Transform Function to Produce a Mechanical Property of a Subterranean Structure

(76) Inventor: Niranjan C. Banik, Richmond, TX (US)

(21) Appl. No.: 13/070,508

(22) Filed: Mar. 24, 2011

Related U.S. Application Data
(60) Provisional application No. 61/320,048, filed on Apr. 1, 2010.
(60) Provisional application No. 61/351,674, filed on Jun. 4, 2010.

(51) Int. Cl. G06F 19/00; G01V 3/00

(52) U.S. Cl. 702/7; 702/2

(57) ABSTRACT

A transform function is useable to map a characteristic (e.g., acoustic impedance, shear impedance, density, and/or other characteristic) to a mechanical property (e.g., Young's modulus or other mechanical property). Values of the characteristic can be derived based on surface survey data, and such values can be mapped to respective values of the mechanical property using the transform function.

### CROSS REFERENCE TO RELATED APPLICATIONS

This application claims the benefit under 35 U.S.C. §119(e) of U.S. Provisional Application Ser. No. 61/320,048 entitled “YOUNG'S MODULUS FROM ACOUSTIC IMPEDANCE,” filed Apr. 1, 2010, and U.S. Provisional Application Ser. No. 61/351,674 entitled “LITHO DENSITY FROM ACOUSTIC IMPEDANCE,” filed Jun. 4, 2010, both of which are hereby incorporated by reference.

### BACKGROUND

Various techniques can be used by well designers to derive properties of subterranean structures such that efficient, safe, and practical wells and associated completion systems can be designed. However, conventional techniques of deriving such properties of subterranean structures can be time-consuming and inefficient.

### SUMMARY

In general, according to some embodiments, well log data relating to a subterranean structure is received, and a characteristic (e.g., acoustic impedance, shear impedance, and/or density) is derived using the well log data. Moreover, a mechanical property (e.g., Young's modulus) of the subterranean structure is derived using the well log data. A transform function is then built based on cross-correlating the characteristic and the mechanical property.

In further embodiments, the transform function can be used for deriving the mechanical property based on surface survey data collected for a subterranean structure.

Other or alternative features will become apparent from the following description, from the drawings, and from the claims.

### BRIEF DESCRIPTION OF THE DRAWINGS

Some embodiments are described with respect to the following figures:

FIG. 1 is a schematic diagram of an example arrangement incorporating some embodiments;

FIGS. 2A-2C are graphs illustrating various parameters as functions of depth, that allow for cross-correlating of the parameters to produce a transform function according to some embodiments;

FIGS. 3A-3B are graphs illustrating cross-plotting of a mechanical property to shear and acoustic impedances, respectively, in accordance with some embodiments;

FIG. 4 is a flow diagram of a process of building a transform function according to some embodiments; and

FIG. 5 is a flow diagram of mapping surface survey data to a mechanical property of a subterranean structure using a transform function, according to further embodiments.

### DETAILED DESCRIPTION

Understanding certain mechanical properties of subterranean structures can be beneficial for designing wells and associated completion systems for recovering fluids (e.g., hydrocarbons, water, and so forth) from subterranean reservoirs. One example of such a mechanical property is a Young's modulus of a subterranean structure, where the Young's modulus is a measure of elastic stiffness of the subterranean structure. More specifically, the Young's modulus describes tensile elasticity, or the tendency of an object (in this case a portion of a subterranean structure) to deform along an axis when opposing forces are applied along that axis. Young's modulus is defined as the ratio of tensile stress to tensile strain. Young's modulus is also referred to simply as an elastic modulus.

The Young's modulus can be used by well designers to determine the fracability of certain portions of the subterranean structure, as well as wellbore stability. Wellbore stability refers to an ability of the wellbore to avoid collapse or deformation due to subterranean forces. The fracability of a portion of a subterranean structure refers to the ability of a well operator to fracture the subterranean structure portion using fracturing techniques, such as by injecting high-pressure fluids into a well to fracture rocks in the subterranean structure portion such that fluid-flow tunnels are created.

Certain hydrocarbon reservoirs are recovered by drilling horizontal or highly deviated wellbores through the subterranean reservoirs. Thus, the Young's modulus can be used to determine how stable such horizontal or deviated wellbores will be, as well as to determine the fracability of the subterranean structures surrounding the wellbores.

For isotropic solids, Young's modulus (E) is written as:

E=2G(1+σ), (Eq. 1)

where G is a shear modulus and σ is Poisson's ratio. From the foregoing, the Young's modulus, E, can be rewritten in terms of the shear impedance IS and density ρ, as:

E=2/S²(1+σ)/ρ. (Eq. 2)

where P represents density. The Poisson's ratio (σ) can be written in terms of the acoustic and shear impedances, IP and IS, respectively:

σ=0.5(IP²−2IS²)/(IP²−IS²) (Eq. 3)

For transversely isotropic solids, there are two Young modulii and Poisson's ratios, one in the longitudinal direction and the other in the transverse direction. In this discussion, for simplicity, isotropic solids are assumed, although the subsurface environment may be substantially anisotropic. Techniques according to some embodiments are applicable to both isotropic and anisotropic subterranean structure portions.

Although reference is made to the Young's modulus in the discussion herein, it is noted that techniques according to some embodiments can also be applied to other types of mechanical properties that describe subterranean structures.

From the above definitions, it can be seen that an estimation of Young's modulus is based on elastic parameters IP and IS (or σ) and density ρ. Such parameters are derivable by using prestack inversion of surface survey data collected using surface survey equipment. “Surface survey data” refers to survey data collected by survey receivers located at or above an earth surface above the subterranean structure that is being studied. Surface survey data is contrasted to survey data collected using a tool located in a wellbore drilled into a subterranean structure. Surface survey data can include surface seismic data or surface electromagnetic (EM) data.

Prestack inversion techniques can be used to transform angle or offset data collected using surface survey equipment into the foregoing parameters (e.g., IP, IS, or ρ). To compute acoustic impedance IP, near offset or near angle data is used, while for shear impedance IS or density ρ, increasingly longer offset or angle data is used. Offset refers to the relative distance between a source and a receiver of the survey equipment, while angle refers to the relative angle between the source and receiver. Near offset refers to an offset between the source and receiver that is relatively close to each other, while near angle refers to a relatively small angle between the source and receiver.

In accordance with some embodiments, the ability to derive the foregoing characteristics of a subterranean structure (including acoustic impedance IP, shear impedance IS, and density ρ) from surface survey data presents an opportunity to transform such characteristics into a mechanical property (such as Young's modulus) that is of interest to a well designer.

Techniques according to some embodiments include two stages. A first stage involves building a transform function that correlates characteristics such as acoustic impedance, shear impedance, and/or density, to a mechanical property such as Young's modulus. A second stage involves collecting surface survey data, deriving at least one characteristic of the subterranean structure (such as acoustic impedance, shear impedance, and density) from the surface survey data, and using the transform function to map the characteristic to the mechanical property such as Young's modulus.

In the second stage, after surface survey data for the subterranean structure is collected, techniques (such as prestack inversion techniques) can be applied to derive any one of the foregoing characteristics (acoustic impedance, shear impedance, and density) and/or other characteristics from the surface survey data. Based on such characteristics derived from the surface survey data, the transform function can then be applied to compute the mechanical property (e.g., Young's modulus) of the subterranean structure. By being able to apply the transform function to calculate the mechanical property of the subterranean structure from characteristic(s) derived from survey surface data, a more efficient way of determining the mechanical property is provided.

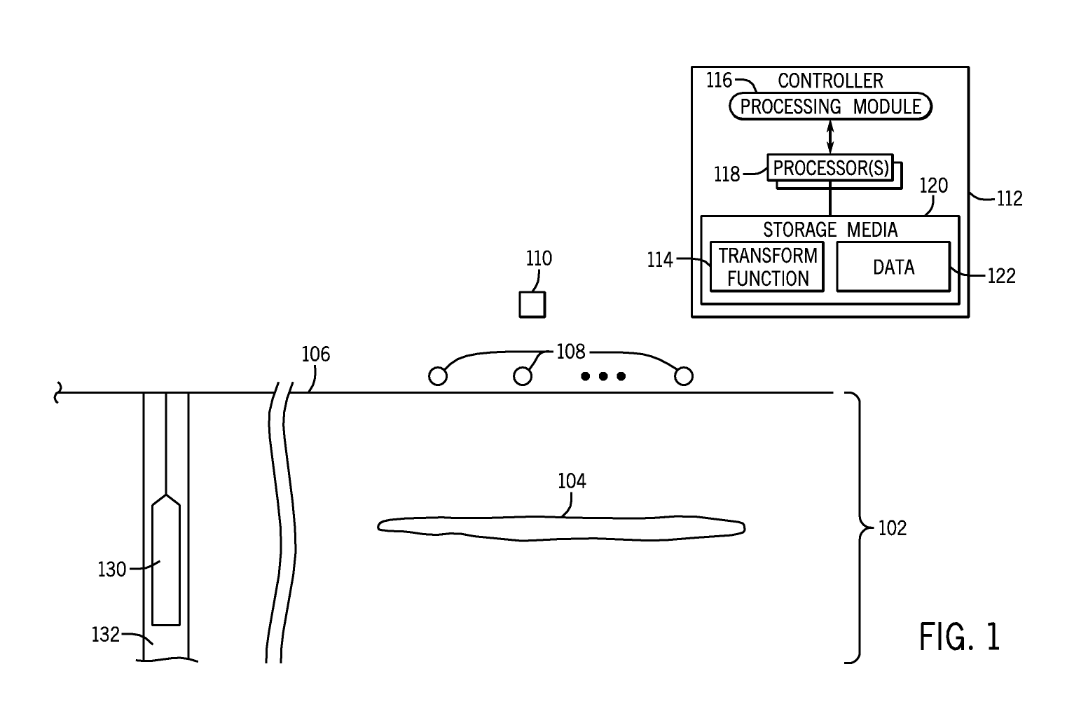

FIG. 1 illustrates an example arrangement useable for determining a mechanical property of a subterranean structure 102, in accordance with some embodiments. As noted above, the mechanical property that can be determined is a rock-physics parameter such as Young's modulus. In other embodiments, techniques or mechanisms according to some embodiments can be used for deriving other mechanical properties of subterranean structures.

The subterranean structure 102 includes a subterranean reservoir 104 (or multiple subterranean reservoirs), which can contain hydrocarbons such as oil or gas, fresh water, or other content. The subterranean structure 102 is located above an earth surface 106.

A surface subterranean survey system that includes survey receivers 108 and at least one survey source 110 can be provided to collect survey data relating to the subterranean structure 102. For example, the survey receivers 108 can be seismic receivers, and the survey source 110 can be a seismic source. A seismic source produces seismic waves that are propagated into the subterranean structure 102, where a portion of such seismic waves are reflected by elements of the subterranean structure 102 towards the earth surface 106. The reflected seismic waves are detected by seismic receivers 108. Recorded data at the seismic receivers 108 can be later processed by a controller 112.

In alternative implementations, the survey receivers 108 can be electromagnetic (EM) receivers, while the survey source 110 can be an EM source. An EM source produces EM waves that are propagated into the subterranean structure 102. The propagated EM waves are affected by the subterranean structure 102, and the affected EM waves are detected by the EM receivers 108. Data recorded at the EM receivers 108 can be processed by the controller 112.

The survey receivers 108 are considered to be located at or above the earth surface 106. A surface receiver is at the earth surface 106 if the survey receiver sits on the earth surface 106, is partially buried in the earth surface 106, or is buried within the earth surface 106 to within some predefined shallow depth, such as less than 20 meters.

As shown in FIG. 1, the controller 112 includes a transform function 114 which is built using techniques according to some embodiments. The transform function 114 is used for mapping a characteristic of the subterranean structure 102 derived from surface survey data (collected by the survey receivers 108 located at or above the earth surface 106) to a mechanical property of the subterranean structure 102, such as the Young's modulus of the subterranean structure 102.

The characteristic that can be mapped to the Young's modulus can be an impedance, such as an acoustic impedance and/or shear impedance as discussed above. The impedance characteristic is an example of a velocity-based characteristic, since impedance is computed based on taking the product of velocity and density of the subterranean structure.

Another velocity-based characteristic is the velocity associated with the subterranean structure 102, where the velocity can be derived from surface survey data and mapped by the transform function according to some implementations to the Young's modulus.

Another characteristic derivable from surface survey data is the density of the subterranean structure, which can also be mapped by the transform function to the Young's modulus. In other embodiments, other characteristics can be derived from the surface survey data and mapped by the transform function to the Young's modulus or another mechanical property.

As further depicted in FIG. 1, the controller 112 includes a processing module 116 that is executable on one or multiple processors 118. The processor(s) 118 is (are) connected to storage media 120, which can be implemented with one or multiple disk-based storage devices and/or one or multiple integrated circuit or semiconductor storage devices and/or one or more other types of storage devices.

The transform function 114 can be stored in the storage media 120. In some examples, the transform function 114 can be built or created at a remote location, such as at another controller (not shown), and communicated over a network (wired or wireless) to the controller 112 for storage in the storage media 120. In other examples, the transform function 114 can be built at the controller 112, such as by the processing module 116.

The storage media 120 also stores data 122, which can include surface survey data collected by the survey receivers 108. In some examples, such surface survey data 122 can be mapped using the transform function 114 to the Young's modulus or another mechanical property of the subterranean structure 102. The transform function 114 can be invoked by the processing module 116, for example.

To build the transform function 114, well log data is collected, where well log data is collected by using sensors of a well log tool 130 lowered into a wellbore 132 drilled into the subterranean structure 102 (or a different subterranean structure). The well log tool 130 includes sensors that are able to acquire certain types of data, such as sonic data, density data, shear data, or other types of data. The sensors of the well log tool 130 detect such data in response to stimuli from sources that can be located in the wellbore 132 or at the earth surface 106.

Note that the wellbore 132 does not have to be drilled into the subterranean structure 102 that is being studied. In such implementations, the wellbore 132 of FIG. 1 can be an existing wellbore drilled into another subterranean structure that is similar to the subterranean structure 102. Similarity of the subterranean structure in which the wellbore 132 is located and the subterranean structure 102 can be based on a well designer's understanding or prediction of the content of the subterranean structures. For example, the well designer may understand that the subterranean structure 102 contains shale rock, such that well log data collected by a well log tool in a wellbore located in another subterranean structure that also has shale rock can be used to build a transform function that is useable for deriving a mechanical property of the subterranean structure 102 being studied.

Alternatively, an investigative wellbore such as the wellbore 132 can be drilled into the subterranean structure 102 being studied, to allow for building of a more accurate transform function 114.

From the well log data, a velocity-based characteristic (e.g., acoustic impedance, shear impedance, and/or velocity) or other characteristic (e.g., density) can be derived. Also, a mechanical property such as the Young's modulus can also be derived from the well log data. The characteristic and mechanical property of the subterranean structure derived using the well log data can be cross-correlated to each other to allow for building of the transform function 114.

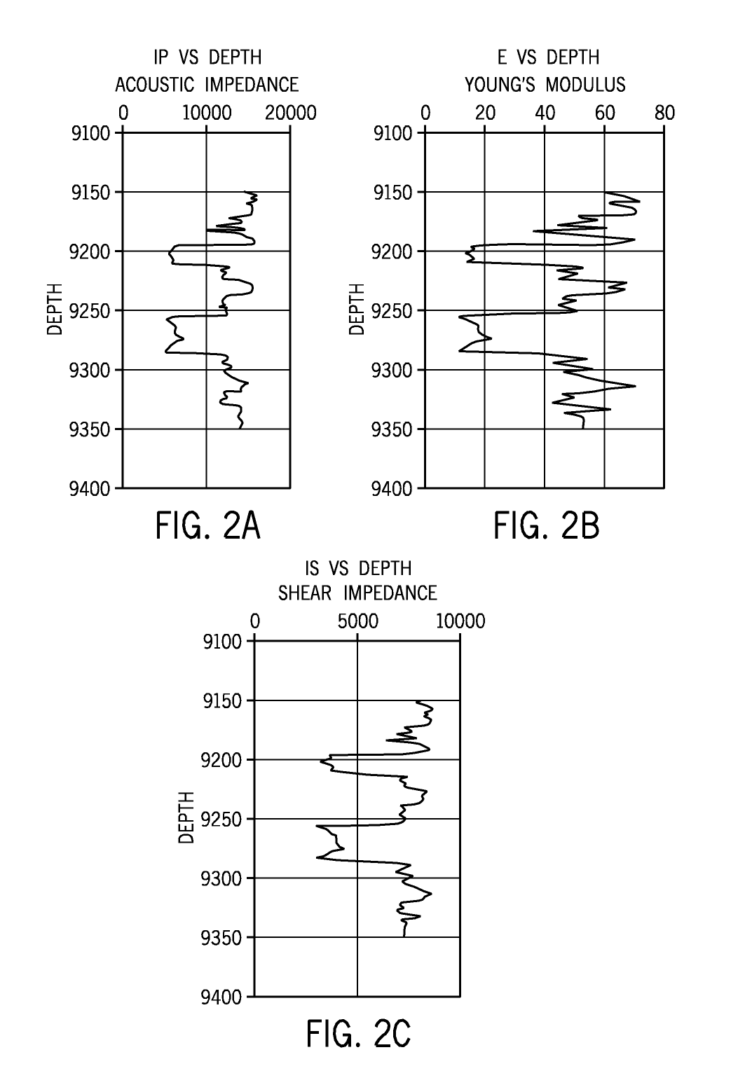

FIGS. 2A-2C illustrate examples of various parameters that can be derived from the well log data. FIG. 2A is a graph of values of acoustic impedance (IP) as a function of depth in the subterranean structure 102. FIG. 2B is a graph of the Young's modulus (E) as a function of depth, and FIG. 2C is a graph of shear impedance (IS) as a function of depth. Note that the parameters of FIGS. 2A-2C are derived from well log data collected using sensors of the well log tool 130 of FIG. 1.

For certain types of subterranean structures, such as subterranean structures containing shale rock or other stiff formations, there is a relatively high degree of correlation between the Young's modulus of FIG. 2B and each of the acoustic impedance and shear impedance of FIGS. 2A and 2C.

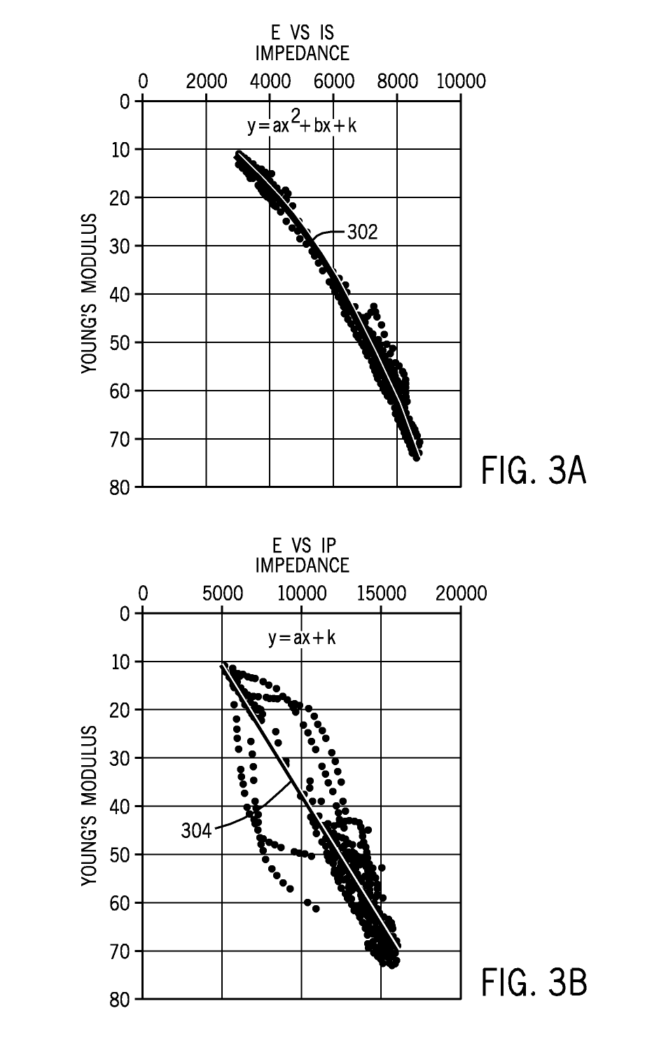

A cross-correlation can be performed between the Young's modulus of FIG. 2B and either the acoustic impedance or shear impedance (or both) of FIG. 2A or 2C. Cross-correlation can involve performing a cross-plot of the Young's modulus to either the shear impedance or the acoustic impedance, such as shown in FIG. 3A or 3B, respectively.

FIG. 3A shows a curve 302 derived from cross-plotting of the Young's modulus and the shear impedance of FIGS. 2B and 2C, respectively. The curve 304 represents a transform function that is a polynomial transform function having the form y=ax²+bx+k, where a, b, and k are coefficients of the transform function derived based on the cross-plotting of the Young's modulus to the shear impedance. In the foregoing polynomial transform function, the Young's modulus is represented as y, and the acoustic impedance is represented as x. The curve 302 is estimated based on various points resulting from cross-plotting values of the Young's modulus (of FIG. 2B) at various depths to values of the shear impedance (of FIG. 2C) at various depths.

In FIG. 3B, a line 304 represents a transform function that correlates the Young's modulus and the acoustic impedance of FIGS. 2B and 2A, respectively. If the Young's modulus is represented as y, and the acoustic impedance is represented as x, then the transform function represented by the line 302 can be expressed as follows: y=ax+k, where a and k are coefficients derived based on cross-plotting the Young's modulus to the acoustic impedance. The line 304 is estimated based on various points resulting from cross-plotting values of the Young's modulus (of FIG. 2B) at various depths to values of the acoustic impedance (of FIG. 2A) at various depths. The transform function represented by line 302, is a linear transform function, in some examples.

The transform function can be of a general polynomial of any order or any other type of function.

In other implementations, cross-plotting between other characteristics (e.g., density or other characteristics) and the Young's modulus can be performed to build other transform functions.

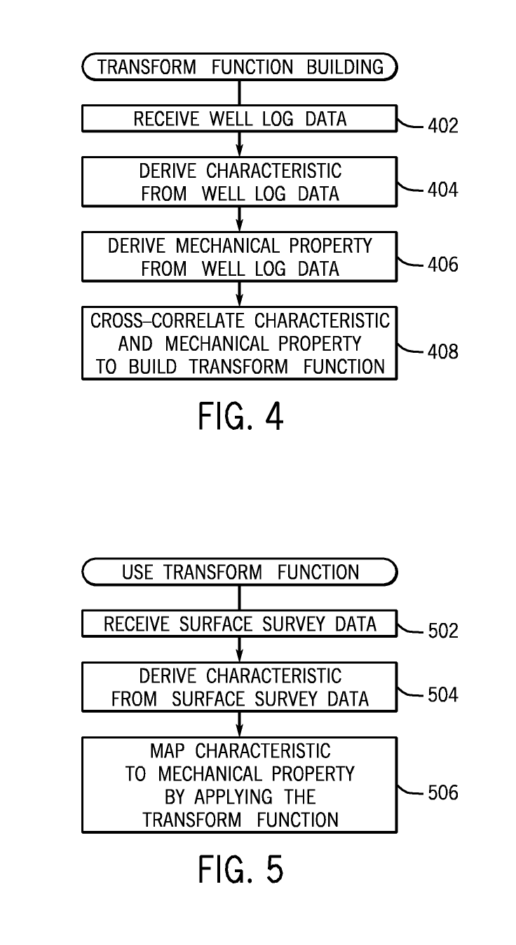

FIG. 4 is a flow diagram of a process of building a transform function, according to some embodiments. The process of FIG. 4 is part of the first stage of techniques according to some embodiments discussed above. The process of FIG. 4 can be performed by the processing module 116 of FIG. 1, or by another processing module in another controller. Well log data is received (at 402), where the well log data is collected using a well log tool (e.g., 150 in FIG. 1) lowered into a wellbore drilled into a subterranean structure being studied, or into a different subterranean structure. A velocity-based characteristic (e.g., acoustic impedance, shear impedance, velocity) or other characteristic (e.g., density or other characteristic) is derived (at 404) from the well log data. Also, a mechanical property (such as Young's modulus) is derived (at 406) from the well log data.

The derived characteristic and derived mechanical property are cross-correlated (at 408) to build a transform function that is useable to map a characteristic derived from surface survey data to the mechanical property of the subterranean structure being studied.

FIG. 5 is a flow diagram of a process of using the transform function according to further embodiments. This is part of the second stage of techniques according to some embodiments discussed above. The process of FIG. 5 can be performed by the processing module 116 of FIG. 1, or by another processing module in another controller. Surface survey data is received (at 502), where the surface survey data is acquired using surface survey equipment. A velocity-based characteristic or other characteristic is derived (at 504) from the surface survey data. The derived characteristic (e.g., acoustic impedance, shear impedance, and/or density) is mapped (at 506) to the mechanical property of the subterranean structure, by applying the transform function built according to FIG. 4.

Once the mechanical property (such as Young's modulus) of a subterranean structure is known, a well designer can design an appropriate well and associated completion systems to allow for efficient, safe, and practical recovery of fluids from a subterranean reservoir. Alternatively, the well can be used to inject fluids into a subterranean reservoir. Using the Young's modulus, a more optimal fracturing mechanism or technique can be implemented. Also, a well operator can know in advance how stable a wellbore (e.g., horizontal or highly deviated wellbore) will be. By using transform functions built using techniques according to some embodiments, the Young's modulus can be more easily derived based on characteristics derived from surface survey data.

Machine-readable instructions of modules described above (including the processing module 116 of FIG. 1) are loaded for execution on a processor(s) (such as processor(s) 118 in FIG. 1. A processor can include a microprocessor, microcontroller, processor module or subsystem, programmable integrated circuit, programmable gate array, or another control or computing device.

Data and instructions are stored in respective storage devices, which are implemented as one or more computer-readable or machine-readable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some or all of these details. Other implementations may include modifications and variations from the details discussed above. It is intended that the appended claims cover such modifications and variations.

What is claimed is:

1. A method comprising:
receiving, by a system having a processor, surface survey data collected for a subterranean structure;
deriving, by the system, a characteristic relating to the subterranean structure; and
transforming, by the system, the characteristic to a mechanical property of the subterranean structure, wherein the transforming is performed using a transform function.

2. The method of claim 1, wherein deriving the characteristic comprises deriving an impedance relating to the subterranean structure.

3. The method of claim 2, wherein the impedance comprises an acoustic impedance.

4. The method of claim 2, wherein the impedance comprises a shear impedance.

5. The method of claim 1, wherein deriving the characteristic comprises deriving a density of the subterranean structure.

6. The method of claim 1, wherein transforming the characteristic to the mechanical property comprises transforming the characteristic to a measure of elastic stiffness of the subterranean structure.

7. The method of claim 6, wherein the measure of elastic stiffness comprises a Young's modulus of the subterranean structure.

8. The method of claim 1, further comprising:
receiving well log data relating to the subterranean structure or a different subterranean structure; and
building the transform function based on the well log data.

9. The method of claim 8, wherein building the transform function comprises:
deriving values of the characteristic based on the well log data;
deriving values of the mechanical property based on the well log data; and
cross-correlating the values of the characteristic to the values of the mechanical property to build the transform function.

10. The method of claim 9, wherein the cross-correlating comprises cross-plotting the values of the characteristic to the values of the mechanical property.

11. The method of claim 9, wherein the characteristic comprises one or both of an acoustic impedance and shear impedance, and the mechanical property comprises a Young's modulus of the subterranean structure.

12. An article comprising at least one machine-readable storage medium storing instructions that upon execution cause a system having a processor to:
receive well log data relating to a subterranean structure;
derive a characteristic of the subterranean structure using the well log data;
derive a mechanical property of the subterranean structure using the well log data; and
build a transform function based on cross-correlating the characteristic and the mechanical property.

13. The article of claim 12, wherein the characteristic comprises an impedance relating to the subterranean structure.

14. The article of claim 13, wherein the mechanical property comprises a measure of elastic stiffness of the subterranean structure.

15. The article of claim 14, wherein the measure of elastic stiffness is a Young's modulus of the subterranean structure.

16. The article of claim 12, wherein the instructions upon execution cause the system to further:
receive surface survey data relating to the subterranean structure; and
use the transform function to produce values of the mechanical property using values of the characteristic derived from the surface survey data.

17. The article of claim 16, wherein the surface survey data comprises surface seismic data collected by seismic receivers at or above a surface above the subterranean structure.

18. The article of claim 12, wherein the instructions upon execution cause the system to further:
receive surface survey data relating to a second subterranean structure; and
use the transform function to produce values of a mechanical property of the second subterranean structure based on values of a characteristic of the second subterranean structure derived from the surface survey data.

19. A system comprising:
a storage medium to store well log data; and
at least one processor to:
receive well log data relating to a subterranean structure;
derive a characteristic of the subterranean structure using the well log data;
derive a mechanical property of the subterranean structure using the well log data; and
build a transform function based on cross-correlating the characteristic and the mechanical property.

20. The system of claim 19, wherein the transform function is useable to compute values of the mechanical property based on values of the characteristic derived from surface survey data for the subterranean structure or another subterranean structure.
